(19) United States
(12) Patent Application Publication
(10) Pub. No.: US 2014/0115093 A1
(43) Pub. Date: Apr. 24, 2014

(54) REMOTE DATA EXCHANGE AND DEVICE MANAGEMENT WITH EFFICIENT FILE REPLICATION OVER HETEROGENEOUS COMMUNICATION TRANSPORTS

(71) Applicants: Adam D. Dirstine, Rochester, MN (US); Christopher Glen Popp, Winona, MN (US)

(72) Inventors: Adam D. Dirstine, Rochester, MN (US); Christopher Glen Popp, Winona, MN (US)

(73) Assignee: DIGI INTERNATIONAL INC., MINNETONKA, MN (US)

(21) Appl. No.: 13/656,947

(22) Filed: Oct. 22, 2012

(51) Int. Cl. G06F 15/16

(52) U.S. Cl. 709/217

(57) ABSTRACT

Systems and methods for the remote data exchange and device management with efficient file replication over heterogeneous communication transports. A user or application may provide a server with a communication bundle that may include a command and a data file. A transfer of the bundle from the server to one or more devices coupled to the server by a network over a first protocol may be initiated. Before the completion of the transfer, if a more cost effective connection becomes available the transfer of the bundle from the server to one or more devices may be completed via the more cost effective connection. The bundle may be transmitted in multiple segments. The individual segments may be transferred in any order and over various network protocols, and reassembled at the receiving device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, Digi International Inc. All Rights Reserved.

### BACKGROUND

Sending machine-to-machine (M2M) messages between M2M servers and mobile or embedded devices over commercially available short message service (SMS) protocols and other message based transports can be expensive. Sending status and other infrastructure information between the device and the server is desirable, but because each message may incur a cost excessive M2M communication can be undesirable.

Each SMS message sent or received can be very expensive. SMS messages can cost a user as much as $0.25 per message or more over cellular networks in the United States, and much more outside the U.S. Alternative message based protocols, such as the ORBCOMM® satellite M2M network, can be even more expensive for each message. Because the cost for messaging services over SMS for a device is typically negotiated and incurred by the customer, it makes it nearly impossible for device or application developers to make intelligent cost decisions automatically in the device software because the device or application developers providing the M2M service may not be aware of the cost per message.

Sending machine-to-machine (M2M) messages between devices is difficult to perform efficiently because communication mechanisms can be intermittent and/or expensive.

### Overview

The present inventors have recognized, among other things, that a problem to be solved can include how to efficiently and reliably transfer data and files between devices for little or no cost. The present subject matter can help provide a solution to this problem, such as by prioritizing file transfers over the lowest cost connection, distributing file-transfers over a period of time, and transferring files independently and across heterogeneous transports e.g., communication mechanisms with various connections or protocols.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of a device and a server in communication over a network, in accordance with some embodiments.

FIGS. 2A and 2B illustrate example message structures, in accordance with some embodiments.

FIG. 3A illustrates a flow diagram of an example scheme for transferring files over multiple protocols, in accordance with some embodiments.

FIG. 3B illustrates a flow diagram of an example scheme for selecting a transfer protocol, in accordance with some embodiments.

FIG. 4 illustrates an example interaction diagram of a device and a server, in accordance with some embodiments.

FIG. 5 illustrates a block diagram of an example machine upon which any one or more of the techniques discussed herein may be performed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A need exists to efficiently transfer data, such as for data exchange and device management, to devices in a manner that maximizes cost efficiency and reliability when the transfer happens over a long period of time, across any number of communication sessions, or over any number of heterogeneous types of communication connections or protocols, such as Wi-Fi, cellular data, SMS, satellite, and the like.

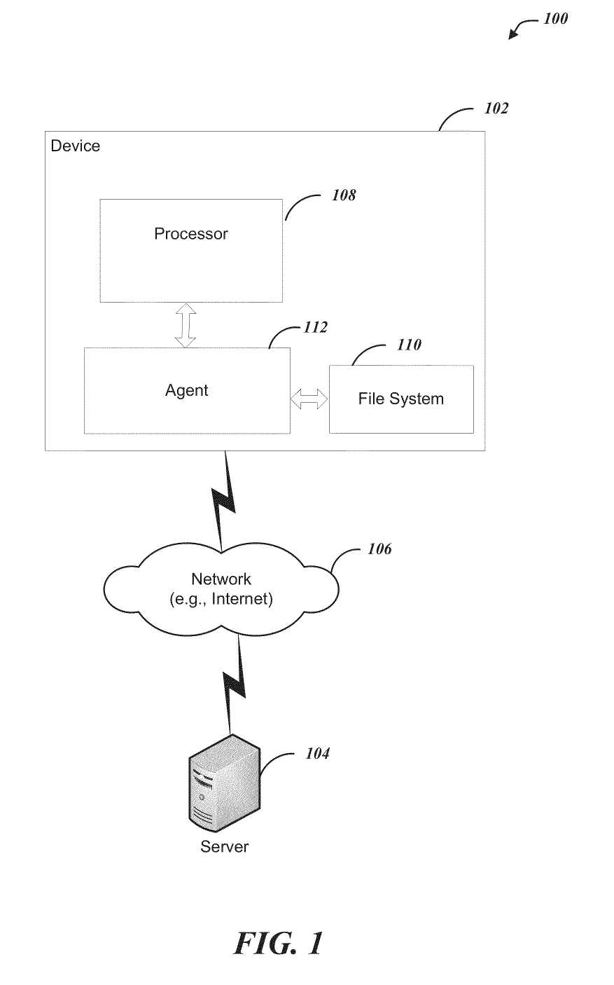

FIG. 1 illustrates a block diagram 100 of a device 102 and a server 104 in communication over a network 106. Device 102 may include a processor 108 and file system 110 for exchange of data, commands, and files over the network 106. Device 102 may include a user interface that allows a user to manipulate the device 102 or to input information to be communicated to server 104, or one or more data sensors that may acquire data from an environment proximate to device 102. Device 102 may include an agent module 112 configured to initiate or receive machine-to-machine (M2M) communication, e.g., messages or files, between the device 102 and the server 104. M2M communication may include file transfers, sensor readings, device status messages, device commands, or any of a variety of other communication data. Examples of device 102 may include smart phones, personal digital assistants, personal computers, networked appliances, Xbee® wireless modules, or any other machine or device capable of communicating over a wired or wireless network.

Examples of server 104 may include any wired or wireless device coupled to network 106. For example, a server 104 may include a personal computer, a smart phone, a personal digital assistant, a cloud-based computing or monitoring service, or any other network capable device. The server 104 may communication with a plurality of devices, such as multiple embodiments of device 102.

The network 106 may include any of a variety or combination of wired or wireless networks such as mobile, cellular, satellite, Internet, intranet, or other communication networks and utilize any variety of data transmission protocols. Communications between a device 102 and a server 104 over a network 106 may include directly sending a message, and explicitly incurring a cost for the communication when a fee-based data service is used. For example, a M2M messaging between a device 102 and a server 104 over a commercially available short message service (SMS) may incur transaction costs on a per message basis. Communication over a fee-based SMS protocol may be limited to a specified number of messages, or amount of data, for a specified time period.

An alternative to utilizing per-message SMS costs, is for device 102 to attempt to communicate with the server 104 using a data service to exchange messages. For example, cellular carriers offer and provide subscription mobile data services, which are available from a variety of service providers with various levels of cost and service. However, the cost of a data service connection often requires a monthly subscription fee, and data service coverage may not be available or reliable in all geographic locations. Communication over a subscription data service may be limited to a specified amount of data for a specified time period. For example, a server 104 may be limited to sending one-gigabyte of data to any particular device 102 in any individual month.

An alternative to SMS communication or cellular data service connections is a private or publically available Wi-Fi connection. As many municipalities, business, and others make Internet connected Wi-Fi hot spots available for public use, a device 102 may be able to connect to network 106 through a free or fixed-cost wireless connection. In an example, a plurality of embodiments of device 102 may be located in a building, complex or campus of a single organization such as a corporation or university campus. Each device 102 may be configured to access a private Wi-Fi enabled network maintained by the organization in order to transact communication with server 104.

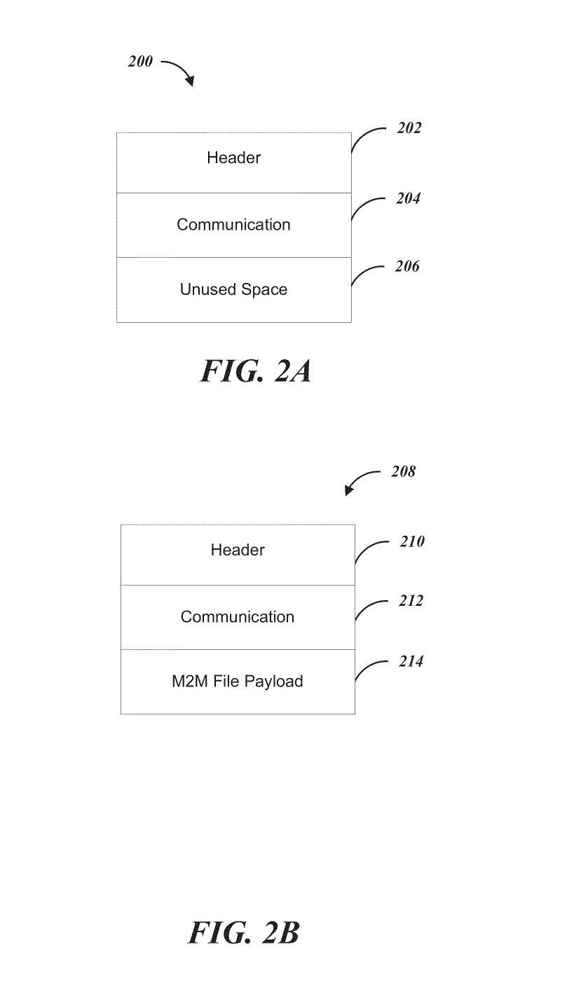

FIG. 2A illustrates an example message structure 200 that may be used to communicate between devices, between one or more devices and a server, or any combination of networked devices, machines, clients, or servers that are coupled to a network. Example message structure 200 includes a header 202 that may include protocol identifiers, data coding scheme information, time stamp data, origin and destination information, and any other information appropriate to send, route, and receive a message for a particular protocol. Message structure 200 also includes a communication payload 204 that may be independent of any machine-to-machine messaging. Depending on the size of communication payload 204 relative to the message structure 200, a portion of unused space 206 may exist in message structure 200.

FIG. 2B illustrates an example message 208 that includes a header 210, a communication payload 212, and an embedded M2M file payload 214. The embedded M2M file payload 214 utilizes the payload space available to the communication payload 212 that is unused. In an example, the communication payload 212 and the M2M file payload 214 may be combined into a combination payload package for transmission from a device or a server.

In an example, server 104 may embed messages containing commands, data, system status, or other information in unused portions of standard messaging structures, as detailed in FIG. 2B above. Device 102 may receive, over network 106, messages that may include embedded message content, and extract the embedded message content from the messages. Additional information regarding embedding message data with communication may be found in U.S. patent application Ser. No. 13/612,404, titled EMBEDDED COMMUNICATION IN MESSAGE BASED TRANSPORTS, filed on Sep. 12, 2012, (attorney docket no. 977.201US1), which is hereby incorporated by reference herein in its entirety. For example, managing devices and transferring data to devices may be accomplished by transferring files to one or more devices in a device cloud, e.g., networked, environment. The transfer of files may utilize any amount of spare communication capacity such as is often available with SMS and other message based protocols to minimize data costs.

An example of efficient transfer of data to devices, such as for data exchange and device management, may be performed in a manner that maximizes cost efficiency and reliability by performing the transfer over a long period of time, across any number of heterogeneous communication sessions, or over any number of different types of communication protocols (e.g., Wi-Fi, cellular data, SMS, satellite, etc). In this manner, the distribution of files from a first device to one or more other managed devices may be performed in very cost efficient and reliable manner.

Additionally, files may be constructed and transferred independently and across multiple communication sessions, allowing the transfer to be done over unreliable communication mechanisms, or over relatively long periods of time, so that transfers can be scheduled in a fine-grained manner. For example, arbitrary sized chunks of the file may be sent as individual segments rather than full files in order to take advantage of cost or other factors related to maximizing transfer efficiency.

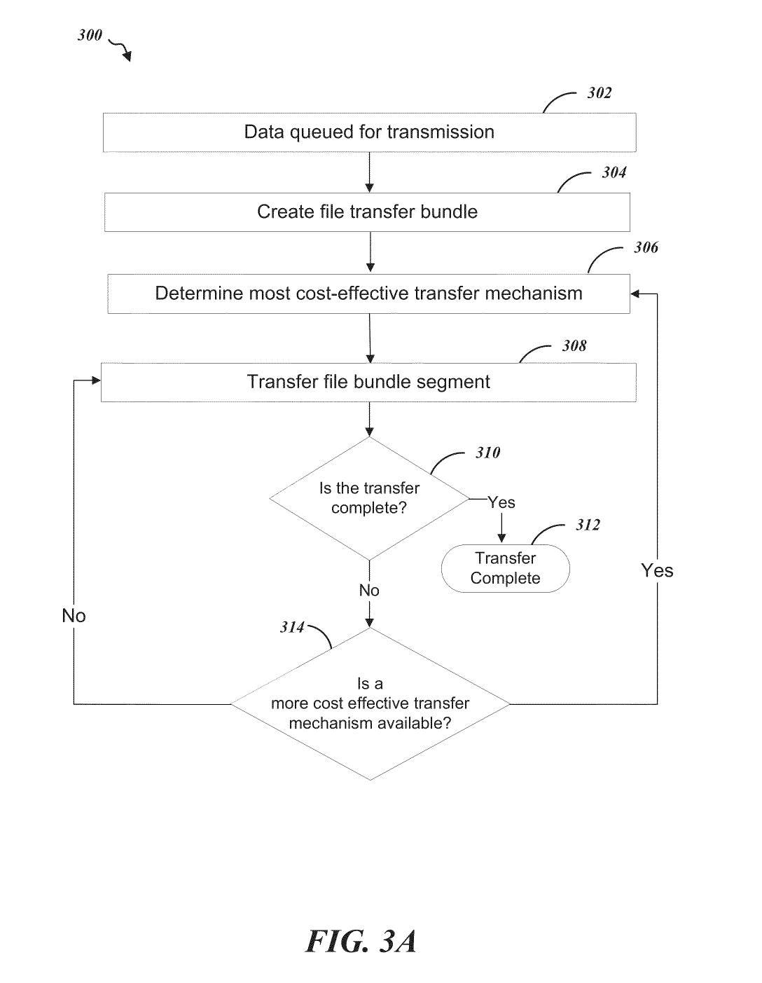

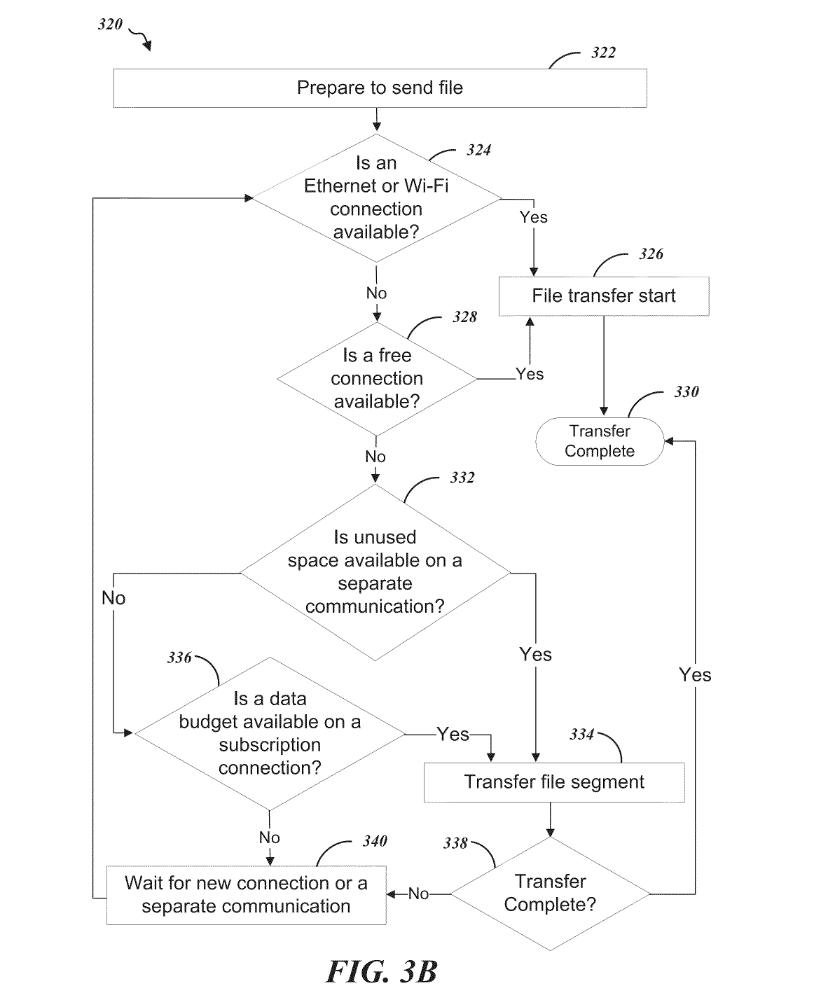

FIG. 3A illustrates a flow diagram of an example scheme 300 for transferring files over one or more protocols. At 302, data is queued for transmission from a first device to a second device. For example a command structure or file may be queued at server 104 for distribution to one or more embodiments of device 102.

At 304, the first device generates a command file. The queued data may be arranged in the command file such that the command file may be used to bundle requests from the first device to the second device. The bundled commands may be device management related, such as a request to write a file to the device's file system, execute a firmware update, other device commands, or a user data transfer from the server to the device, such as a user data block being sent from the server to a user program, e.g., a Python program, running on the device.

A command file may be arranged to include: a request identifier, a file length, a signature of the file, and data contents or payload. The request identifier may be a unique id generated by the first device to identify this replication request. Each replication request includes a new request id that may be used to identify a transfer. The file length may indicate the total length of the file being transferred. The signature of the file may be a hash, e.g., SHA1 or CRC32, over the entire contents of the file. The hash may be set to all zeros for purposes of generating the signature.

The data contents or payload includes a binary section of data that may be interpreted by a command processor on the device, and compressed for transport. Contents after compression inflation may include for example, a command and data where the command indicates the data included is a file to be placed in the file system of the second device with a specified name. The contents may also include a firmware image, or a command request for the second device to execute.

For example, if a user wishes to transfer a file to a device 102, the user may upload the file to the server 104 in a server side file system directory. The server 104 may then generate a command file as specified above. The server 104 may stage the request if multiple file transfers are requested.

At 306, the first device may determine the most cost-effective transfer mechanism to transfer the file to the second device. The most cost effective transfer mechanism may include a determination of both the most efficient in terms of speed, and the mechanism that is most likely to minimize the financial costs of the transfer.

When a cost-effective transfer mechanism is determined, at 308, the first device begins the transfer of a file bundle segment, e.g., a portion of the file or the entire command file, depending on the size of the file. At 310, a check is made to determine if the transfer is complete. If, at 312, the entire payload has been transferred then the transfer is complete. The receiving second device may verify the integrity of the file by comparing the file contents to the size and signature provided with the file.

If, at 314, the transfer is not complete, then a check is made to determine if a more cost-effective transfer mechanism is available. A more cost-effective transfer mechanism may include a newly available connection between the first device and the second device, or the availability of a lower cost protocol through an existing connection. If a more cost-effective mechanism is not available, then at 308, another file bundle segment is transferred with the existing transfer mechanism. If a more cost-effective mechanism is available, at 306, the most cost-effective transfer mechanism is determined and the process continues as above.

FIG. 3B illustrates a flow diagram of an example scheme 320 for determining the most cost-effective transfer mechanism. At 322, preparations are made to send a file from a first device to a second device, for example, as described above with respect to FIG. 3A. Once data, in a file, or other data structure is prepared for transfer a device may attempt to determine which transfer mechanisms are available between the sending first device and receiving second device.

At 324, if the first device is connected via an Ethernet or a Wi-Fi connection that does not require a fee for use, then, at 326, the file transfer is started and the entirety of the file is transferred to the device. The entirety of the file may be transferred at the maximum rate that the Ethernet or Wi-Fi connection is capable of supporting in order to maximize the use of the low-cost data connection. If an Ethernet or Wi-Fi connection is not available, at 328, any other available free, or no fee, transport is selected, then, at 326, the file transfer is started and the entirety of the file is transferred to the device.

In one example, at 326, the file transfer is performed in a segmented manner, so that if the transfer is interrupted the full download need not be restarted, but may continue with the interrupted segment when the connection is reestablished, or through an alternative connection mechanism. The file may be transferred in segments of arbitrary size, starting at the beginning and moving through the file. The segments may be transferred with a request id, a data offset, and the data to be transferred.

The file transfer will continue until all segments of the file are transferred. At 330, the transfer is complete when all segments are received by the second device and the second device reconstructs the segments and verifies the integrity of all of the reconstructed data.

If there are no free or non-fee based connections available, then, at 332, the first device may check to determine if any unused space available on a separate communication mechanism, e.g., a SMS message, to embed a segment of data. At 334 the segment, or part of a segment depending on the unused space available, is transferred to the second device.

If there are no free or non-fee based connections available, and no unused space available on a separate communication mechanism, then, at 336, the first device may determine if a data budget is available on a subscription connection. A subscription connection may include any specified interface (cellular, SMS, Satellite) that provides a data transfer service for a subscription fee. For example, a user may specify a maximum amount of data to be transferred, per period, per device for a subscription connection. If a subscription budget is available, then at 334, transfer a file segment, e.g., an arbitrary amount of the file as determined by the user on the specified interface for the specified period, to the second device.

If, at 336, the data budget is available on a subscription connection is unavailable or previously expended, then, at 340, the first device may wait for a new connection, or a separate communication where unused space is available. The first device may continuously or periodically execute example scheme 320 until a queued file is successfully transferred from the first device to the second device.

In an example, upon receiving a file segment the second device, e.g., device 102 of FIG. 1, may write the received data to a local copy in non-volatile RAM using the request id as a name of temp file and the offset. Additionally, a metadata file, which may be unique per generation id, may be created and updated upon successful completion of a data transfer. The metadata may be utilized to include the offset for each received segment of a file. Contiguous offsets in the metadata file may be collapsed and combined together in order to keep the size of the metadata file to a minimum.

In an example, when the first section of the command file is received, the receiving device is provided with the file length of the file being transferred. Once the receiving device has successfully received the full file length of data, the device may verify a signature of the file, e.g., compute the hash over the file contents. If the verification fails, the transferred is marked failed in a metadata file or error log. If the hash is correct, any commands in the file may be executed and transfer status is updated.

The metadata file may also be updated with a replication status. Example replication status conditions may include: receiving—the device has not yet received the full file, verification failed—a full file was received but replication failed because a computed checksum does not match the checksum in the file, executing—a full file was downloaded and command is executing, success—a command was executed and completed successfully, or error—a command was executed but an error occurred. Additional details, for example an error log, may be created for any of these conditions.

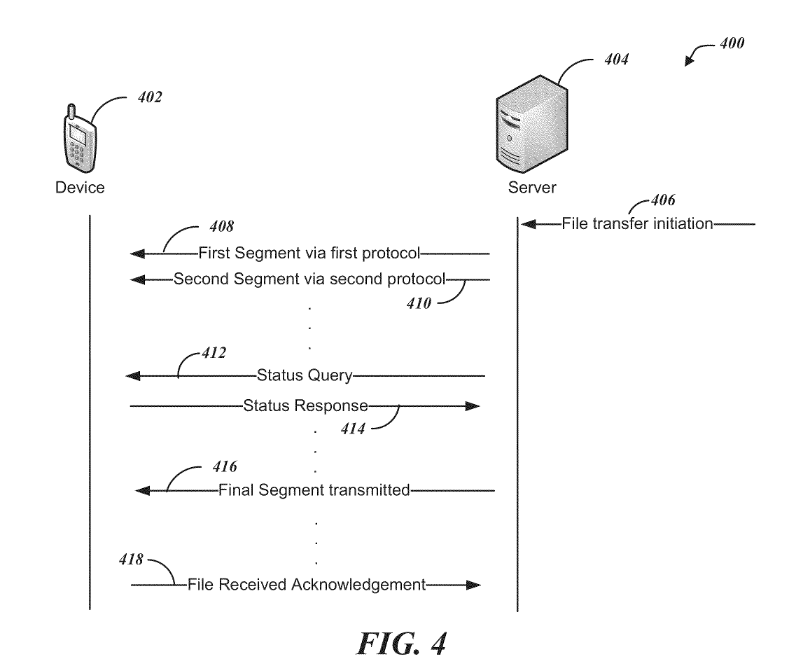

FIG. 4 illustrates an example interaction diagram 400 of a device 402 and a server 404. In the depicted example, a user may wish to initiate a file transfer from server 404 to device 402. At 406 the file is received at the serve 402. The server may package the file for segmented transmission, for example, utilizing scheme 300 or scheme 320 as depicted in FIGS. 3A and 3B. At 408, a first segment of the file is transferred from the server 404 to the device 402. At 410, a second segment of the file may be transferred to the device 402 via a second protocol that the server has determined to be more cost-effective than the first protocol.

At 412, any time after the initiation of the file transfer, the server 404 can request that a metadata file being constructed by device 402 to track the file transfer be sent to the sever 404. At 414, the device 402 may transmit the metadata file, in whole, or in part, to the server 404 by the most cost effective transfer mechanism available between device 402 and server 404. By requesting the metadata file from device 402, the server 404 may discover the current state of the replication and subsequent command execution once the file is transferred. The server 404 may be limited to sending a status query only in situations where the cost of the request is minimal, for example, when a device 402 transitions from a limited communication mechanism (such as an SMS protocol) to a no-fee mechanism such as Wi-Fi. Otherwise, the server 404 may keep a record of which segments and their corresponding offsets have been sent to device 402. The server 404 will continue to send the file contents to the device until, at 416, the final segment is transmitted.

After the final segment is transferred from the server 404 to the device 402, the transfer is considered complete, and the server 404 may request the metadata file from the device 402. If the device did not receive all of a file's segments, the server 404 may resend the segments that are missing, as indicated in the metadata file. In another example, the device 402 may originate, at 418, a file received acknowledgement indication the completion status of the transfer. The server optionally may then request metadata file, and the transfer is complete. An advantage is this approach allows the server 404 to reduce data costs by maximizing the ability of the server 404 to seamlessly use any transport mechanism available, and to reliably restart transfers to one or more devices regardless of state of the transfer.

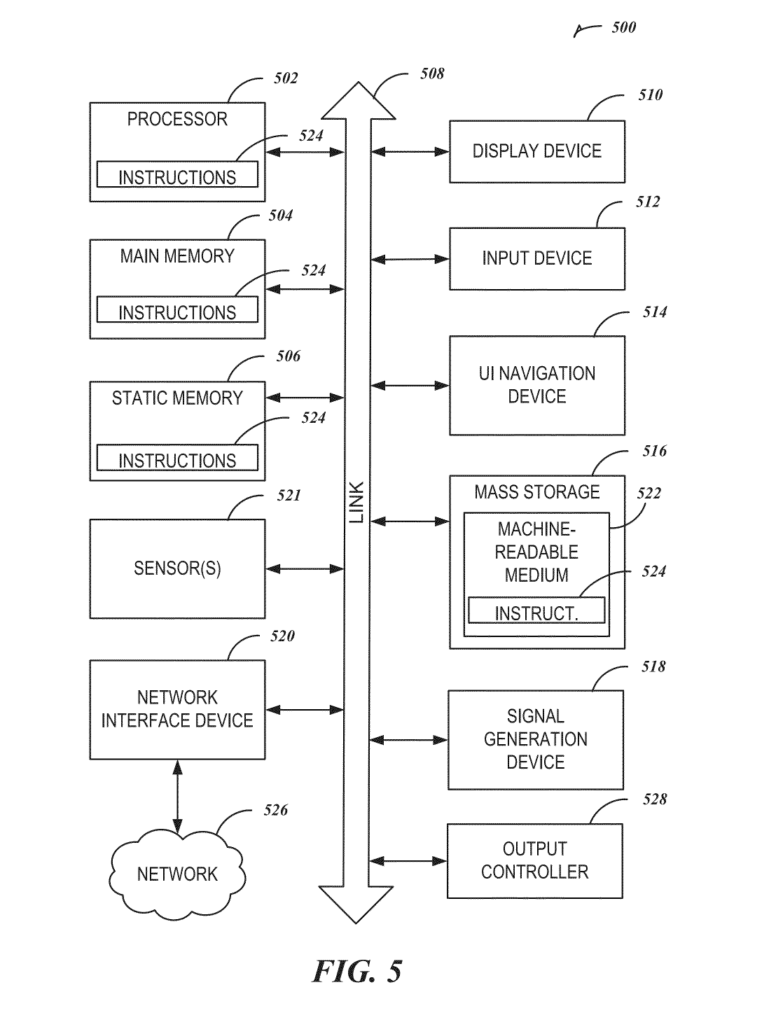

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a processing unit, a graphics processing unit (GPU), a hardware processor core, or any combination thereof), a main memory 504, and a static memory 506, some or all of which may communicate with each other via a link 508 (e.g., a bus, link, interconnect, or the like). The machine 500 may further include a display device 510, an input device 512 (e.g., a keyboard), and a user interface (UI) navigation device 514 (e.g., a mouse). In an example, the display device 510, input device 512, and UI navigation device 514 may be a touch screen display. The machine 500 may additionally include a mass storage (e.g., drive unit) 516, a signal generation device 518 (e.g., a speaker), a network interface device 520, and one or more sensors 521, such as a global positioning system (GPS) sensor, camera, video recorder, compass, accelerometer, or other sensor. The machine 500 may include an output controller 528, such as a serial (e.g., universal serial bus (USB), parallel, or other wired or wireless (e.g., infrared (IR)) connection to communicate or control one or more peripheral devices (e.g., a printer, card reader, etc.).

The mass storage 516 may include a machine-readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage 516 may constitute machine readable media.

While the machine-readable medium 522 is illustrated as a single medium, the term “machine readable medium” may include a single medium or multiple media (e.g., a centralized or distributed database, and/or associated caches and servers) that configured to store the one or more instructions 524.

The term “machine-readable medium” may include any tangible medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for transferring data via heterogeneous transports comprising:
generating a transfer bundle at a first device;
selecting a first transfer protocol, at the first device, for transferring the transfer bundle to a second device, the transfer protocol being selected based on a criterion and a first connection between the first device and the second device;
initiating transfer of a first portion of the transfer bundle with the first transfer protocol via the first connection;
determining that a second transfer protocol exceeds the criterion of the first protocol, and that a second connection between the first device and the second device is available; and
transferring a second portion of the transfer bundle with the second protocol via the second connection.

2. The method of claim 1, wherein generating the transfer bundle includes: receiving a payload, calculating a payload size, and generating a transfer identifier and a payload signature.

3. The method of claim 2, wherein generating the transfer bundle includes associating a device command with a data file.

4. The method of claim 2, wherein generating the payload signature includes performing a hash of the payload.

5. The method of claim 2, wherein generating a transfer identifier includes generating a random value and assigning the random value to the transfer bundle.

6. The method of claim 2, comprising: reconstructing the transfer bundle from the first portion of the transfer bundle and the second portion of the transfer bundle.

7. The method of claim 6, comprising: verifying the integrity of the transfer bundle based on the payload signature.

8. The method of claim 1, the criterion including: an expected cost of transferring the transfer bundle using a specific payload.

9. The method of claim 1, wherein the first protocol operates over a fee-based communication service and the second protocol does not include a transaction cost for data transfer.

10. The method of claim 9, wherein the first protocol and the second protocol are wireless communication protocols.

11. A system comprising:
a first device coupled to a network, the first device being configured to:
generate a transfer bundle that includes: a transfer identifier, a payload size, a payload signature, and a payload;
select a first transfer protocol for transferring the transfer bundle, the transfer protocol being selected based on a criterion;
initiate transfer of a first portion of the transfer bundle via the first transfer protocol;
determine that a second transfer protocol exceeds the criterion of the first protocol; and
continue the transfer of the transfer bundle via the second protocol by sending a second portion of the transfer bundle; and
a plurality of devices configured to communicate over the network, each of the plurality of devices including a module configured to communicate with the first device, the module being configured to reconstruct the transfer bundle from the first portion of the transfer bundle and the second portion of the transfer bundle.

12. The system of claim 11, the criterion including: an expected cost of transferring the transfer bundle using a specific payload.

13. The system of claim 11, the transfer bundle including: a device command and a data file associated with the device command.

14. The system of claim 11, the payload signature includes a hash of the payload.

15. The system of claim 14, wherein the plurality of devices are configured to verify the integrity of the transfer bundle based on the payload signature.

16. The system of claim 11, wherein the network includes a plurality of heterogeneous communication mechanisms.

17. A tangible computer readable medium comprising a plurality of instructions that in response to being executed on a computing device, cause the computing device to:
generate a transfer bundle;
select a first transfer protocol for transferring the transfer bundle, the transfer protocol being selected based on a criterion;
initiate a transfer of the transfer bundle with the first transfer protocol;
determine that a second transfer protocol exceeds the criterion of the first protocol; and
transfer a portion of the transfer bundle using the second protocol.

18. The tangible computer readable medium of claim 17, the transfer bundle including: a transfer identifier, a payload size, a payload signature, and a payload.

19. The tangible computer readable medium of claim 17, comprising: reconstructing the transfer bundle from the first portion of the transfer bundle and the second portion of the transfer bundle.

20. The tangible computer readable medium of claim 19, comprising: verifying the integrity of the transfer bundle based on the payload signature.

21. The tangible computer readable medium of claim 17, the criterion including: an expected cost of transferring the transfer bundle using a specific payload.
